(19) United States
(12) Patent Application Publication
(10) Pub. No.: US 2001/0055054 A1
(43) Pub. Date: Dec. 27, 2001

(54) Card printing apparatus

(76) Inventors: Zenta Kosaka, Matsumoto-shi (JP); Nobutoshi Otsuka, Nagano-ken (JP); Kenichi Nakajima, Nagano-ken (JP)

Correspondence Address: HOGAN & HARTSON L.L.P., 500 S. GRAND AVENUE, SUITE 1900, LOS ANGELES, CA, 90071-2611, US

(21) Appl. No.: 09/838,716

(22) Filed: Apr. 18, 2001

(30) Foreign Application Priority Data
May 15, 2000 (JP) 2000-142193

(51) Int. Cl. B41J 2/01

(52) U.S. Cl. 347/104

(57) ABSTRACT

A card printing apparatus is disclosed which is capable of preventing degradation of print quality even if a card leaves a pair of feed rollers while a print head continues printing operation. The card printing apparatus prints on a card having a predetermined thickness by an ink jet printing method. A pair of feed rollers feed the card forward while urgingly sandwiching the card therebetween. A print head prints on the card being fed, while performing reciprocating motions. A release mechanism causes the pair of rollers to stop urgingly sandwiching the card therebetween. A controller controls the release mechanism such that the release mechanism causes the pair of rollers to stop urgingly sandwiching the card therebetween when a trailing edge portion of the card leaves the pair of feed rollers.

### BACKGROUND OF THE INVENTION

1. Field of the Invention

This invention relates to a card printing apparatus that prints on a card having a predetermined thickness.

2. Prior Art

Conventionally, a card printing apparatus of this kind has been proposed e.g. by Japanese Laid-Open Patent Publication (Kokai) No. 11-254657, which has causes a transfer belt to feed a card together with a tray on which the card is placed, in one direction, and at the same time cause a print head to reciprocate in a direction orthogonal to the direction of feed of the card, thereby carrying out printing as desired.

In the conventional card printing apparatus configured as above, it is difficult to position the card being fed on the tray by the transfer belt. Further, it is also difficult to print a plurality of cards in succession, since the printed card has to be replaced by a new card each time. These inconveniences can be eliminated if cards are fed similarly to ordinary sheets of paper, by feed rollers arranged at upstream and downstream locations. However, if the card is fed by rotation of a pair of rollers by urgingly sandwiching the card therebetween, due to a thickness of the card, the tail portion is flipped off forward by the rollers when the tail portion passes through the rollers. Even if the rear rollers flip the card off, for instance, jamming cannot occur, since the forward rollers are holding the card. However, during the printing, an error in a distance between lines of dots can be caused, to degrade print quality.

### SUMMARY OF THE INVENTION

It is an object of the invention to provide a card printing apparatus which is capable of preventing degradation of print quality even if a card leaves a pair of feed rollers when a print head thereof continues printing operation.

To attain the above object, according to a first aspect of the invention, there is provided a card printing apparatus for printing on a card having a predetermined thickness and a trailing edge portion, by an ink jet printing method.

The card printing apparatus according to the first aspect of the invention is characterized by comprising:

a pair of feed rollers for feeding the card forward while urgingly sandwiching the card therebetween;

a print head for printing on the card being fed, while performing reciprocating motions; and

a release mechanism for causing the pair of rollers to stop urgingly sandwiching the card therebetween; and

a controller for controlling the release mechanism such that the release mechanism causes the pair of rollers to stops urgingly sandwiching the card therebetween when the trailing edge portion of the card reaches a position of the pair of feed rollers.

According to this card printing apparatus, a print head reciprocatingly moves across a card being sent forward by a pair of rollers. During the printing operation, when the trailing edge portion of the card being sent reaches the position of the feed rollers, the controller controls the release mechanism to cause the pair of rollers to stop urgingly sandwich the card therebetween. This releases the trailing end of the card from the feed rollers having urgingly sandwiched the card therebetween, and no flipping force acts on the card.

Preferably, the pair of rollers comprise a driving roller and a driven roller urged toward the driving roller, and the release mechanism causes the pair of rollers to stop urgingly sandwiching the card by freeing the driven roller from an urged condition.

More preferably, the card printing apparatus includes a support shaft on which the driven roller is fitted, and the release mechanism includes a release arm disengageably associated with the support shaft such that the release arm can be shifted between a holding position in which the release arm engages with the support shaft of the driven roller for holding the driven roller in a rolling contact position, and a retracted position in which the release arm is withdrawn from the support shaft, and an actuator for causing the release arm to operate.

According to these preferred embodiment, the release mechanism frees the driven roller from an urged condition, and hence even if the driven roller is not largely moved, it is possible to release the urging force of the driven roller acting on the drive roller. This prevents the flipping force from acting on the card.

Also preferably, the pair of rollers comprise a driving roller and a driven roller urged toward the driving roller, and the release mechanism causes the pair of rollers to stop urgingly sandwiching the card by spacing the driven roller away from the drive roller.

More preferably, the card printing apparatus includes a support shaft on which the driven roller is fitted, and the release mechanism includes a release arm in engagement with the support shaft of the driven roller, the release arm moving the driven roller via the support shaft between a rolling contact position and a spaced-away position, and an actuator for causing the release arm to operate.

According to these preferred embodiments, the release mechanism causes the driven roller to be spaced away from the drive roller, and hence the card is positively freed from the state sandwiched between the rollers. This prevents the flipping force from acting on the card.

Further preferably, the actuator comprises a solenoid.

Further preferably, the actuator comprise a motor, and a cam driven by the motor for rotation, and the cam constitutes a cam mechanism together with the release arm.

According to these preferred embodiments, the source of power of the release mechanism can be formed in a simplified manner and at a low cost.

Preferably, the controller detects an amount of feed of the card effected by the pair of feed rollers, and controls the release mechanism based on results of the detection.

According to this preferred embodiment, the trailing edge portion of the card can be detected by utilizing an amount of feed of the card, and hence the release mechanism can be accurately operated when the trailing edge portion of the card reaches the position of the feed rollers.

To attain the above object, according to a second aspect of the invention, there is provided a card printing apparatus for printing on a card having a predetermined thickness by an ink jet printing method.

The card printing apparatus according to the second aspect of the invention is characterized by comprising:

a card feed mechanism for feeding the card;

a print head for printing on the card being fed, while performing reciprocating motions; and

a controller for controlling the card feed mechanism and the print head,

wherein the card feed mechanism includes feed roller means and delivery roller means arranged at respective upstream and downstream locations in a direction of feed of the card with respect to the print head, and

wherein the controller controls feeding operations of the feed roller means and the delivery roller means in synchronism with a printing operation of the print head.

According to this card printing apparatus, during the printing operation of the print head, the feed roller means and the delivery roller means have their feeding operations controlled. Therefore, when a printing operation is started without the leading edge portion of the card reaching the delivery roller means, or continued when the trailing edge portion of the card leaves the feed roller means, the feed of the card cannot be made inaccurate. This prevents thinned dots from being printed at the leading edge portion or trailing edge portion of the card.

The above and other objects, features, and advantages of the invention will become more apparent from the following detailed description taken in conjunction with the accompanying drawings.

### BRIEF DESCRIPTION OF THE DRAWINGS

FIG. 1A is a side sectional view schematically showing a card printing apparatus according to an embodiment of the invention;

FIG. 1B is a side sectional view schematically showing a card-feeding mechanism of the card printing apparatus according to the embodiment;

FIG. 2 is a plan sectional view schematically showing the card printing apparatus according to the embodiment;

FIGS. 3A to 3C are diagrams which are useful in explaining a printing operation of the card printing apparatus according to the embodiment;

FIGS. 4A and 4B are diagrams which are useful in explaining beyond-edge printing of the card printing apparatus according to the embodiment;

FIGS. 5A to 5C are diagrams which are useful in explaining three methods of the beyond-edge printing in the card printing apparatus;

FIGS. 6A and 6B are diagrams which are useful in explaining the relationship between sizes of ink droplets ejected from a print head and an edge portion of a card;

FIGS. 7A and 7B are diagrams which are useful in explaining the relationship between ink droplets and a surface formed with a droop portion, of a card;

FIG. 8 is a diagram schematically showing a part of the construction of a card printing apparatus according to a second embodiment;

FIG. 9 is a diagram schematically showing a part of the construction of a card printing apparatus according to a third embodiment;

FIG. 10 is a diagram schematically showing a part of the construction of a variation of the card printing apparatus according to the third embodiment;

FIG. 11 is a diagram schematically showing a part of the construction of a card printing apparatus according to a fourth embodiment;

FIGS. 12A and 12B are diagrams which are useful in explaining the relationship between the card and ink droplets hitting thereon, according to the prior art.

### DETAILED DESCRIPTION

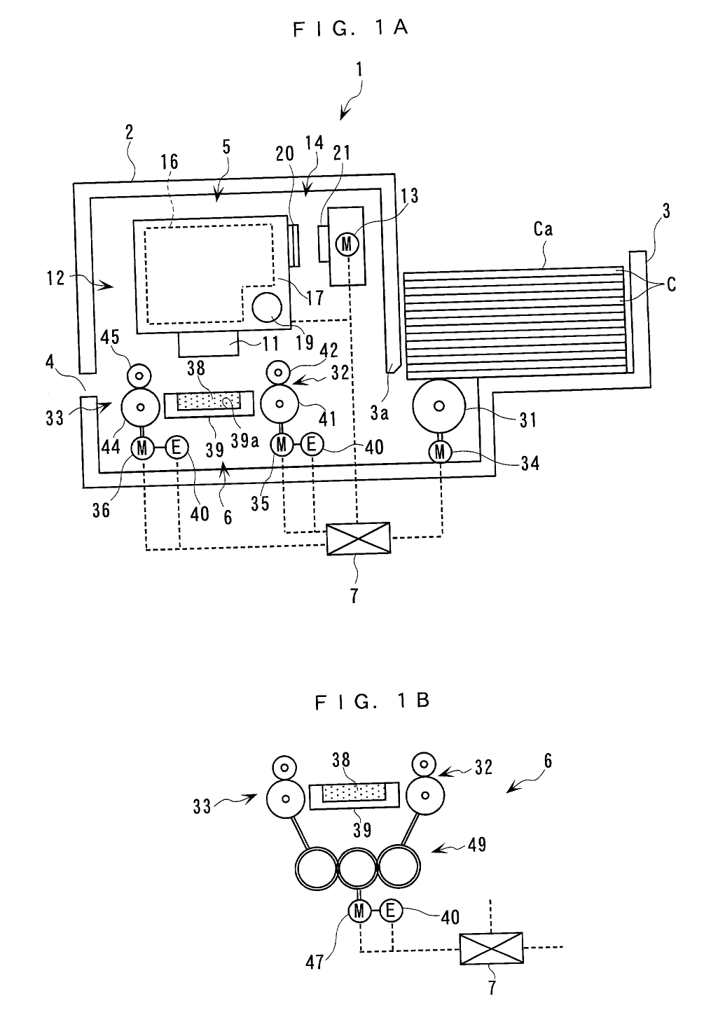

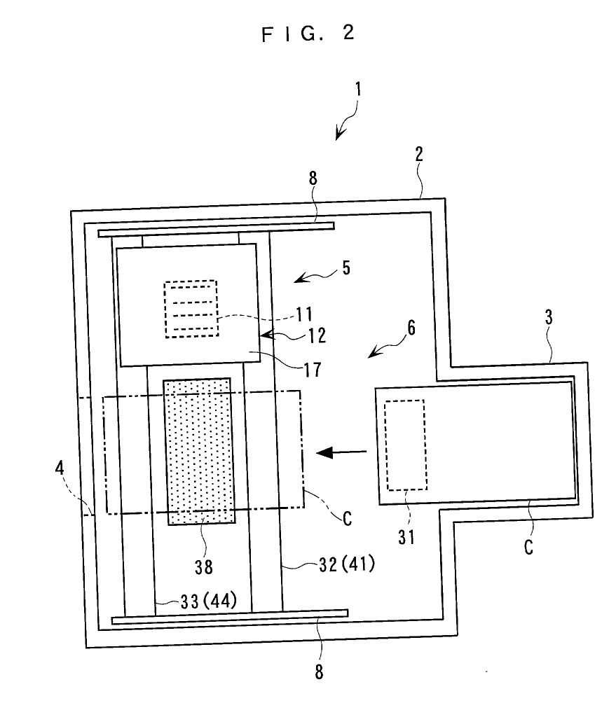

The invention will now be described in detail with reference to drawings showing a card printing apparatus according to embodiments thereof. The card printing apparatus is capable of printing images, such as letters, figures, backgrounds, on a card, such as an ATM card, a membership card, having a predetermined thickness, by an ink jet printing method. The card printing apparatus is configured such that it is capable of performing so-called beyond-edge printing in which ink droplets are ejected beyond edge portions of the card C in view of printing a background of the card. FIGS. 1A and 2 are vertical and horizontal sectional views schematically showing the construction of the card printing apparatus. Referring to the figures, the card printing apparatus 1 includes an apparatus casing 2, a card-setting block 3 and a card exit 4 each formed in a part of the apparatus casing 2, a card printing mechanism 5 and a card feed mechanism 6 each incorporated in the apparatus casing 2, and a controller 7 for controlling the card printing mechanism 5 and the card feed mechanism 6.

A plurality of cards C for use in printing are set in the card-setting block 3 in a state lying one upon another, and introduced from the card-setting block 3 into the card printing mechanism 5 one by one by the card feed mechanism 6. The card C is fed by the card feed mechanism 6 such that card is brought to the card printing mechanism 5, starting with a leading edge thereof, and printed with a desired image by the card printing mechanism 5 by the ink jet printing method. The printed portion of the card C is delivered from the card exit 4 as the printing proceeds.

The card-setting block 3 is formed by laterally protruding a part of the apparatus casing 2 and has an inner shape approximately identical to the shape of the card C. Further, the card-setting block 3 has a predetermined depth enabling a plurality of cards C to be set in a state lying one upon another, and at the same time has a top thereof open such that the cards C can be put in or set from above. The cards C are set in the card-setting block 3 in a state in which a plurality of the cards C are lying one upon another with their recording surfaces Ca facing upward.

The card printing mechanism 5 includes a head unit 12 having a print head (ink jet head) 11, a carriage motor 13 serving as a drive source, and a reciprocating mechanism 14 driven by rotation of the carriage motor 13, for causing the head unit 12 to reciprocate in a direction orthogonal to a direction of feed of each card C. The head unit 12 is comprised of the print head 11 having an array of ink nozzles juxtaposed (in a plurality of lines) on a bottom surface thereof, an ink cartridge 16 for supplying inks (color inks) to the print head 11, and a carriage 17 on which are mounted the print head 11 and the ink cartridge 16.

The reciprocating mechanism 14 includes a carriage guide shaft 19 supported on a pair of left and right block frames, and a timing belt 20 extending in parallel with the carriage guide shaft 19. The carriage 17 is supported by the carriage guide shaft 19 such that it can be caused to reciprocate, and further the carriage 17 is rigidly fixed to a part of the timing belt 20. When the carriage motor 13 is driven for rotation, the timing belt 20 is driven in a forward or reverse direction by rotation of a pulley 21, whereby the head unit 12 is guided by the carriage guide shaft 19 for reciprocation. During this reciprocating motion of the head unit 12, ink droplets are ejected as required for carrying out printing on the card C.

The card feed mechanism 6 includes a supply roller 31 for sending out the cards C one by one from the card-setting block 3, feed roller means 32 for feeding each card C sent from the supply roller 31 to a print position of the head unit 12, and delivery roller means 33 for delivering the card C sent from the feed roller means 32 out of the apparatus from the card exit 4. In this embodiment, the feed roller means 32 and the delivery roller means 33 are arranged at respective upstream (rear-side) and downstream (front-side) locations in the direction of feed of the card C with respect to the print head 11. The supply roller 31, the feed roller means 32, and the delivery roller means 33 are driven for rotation by a supply motor 34, a feed motor 35, and a delivery motor 36 as drive sources, respectively.

Arranged between the feed roller means 32 and the delivery roller means 33 is an ink absorbent material 38 in a manner opposed to the print head 11. The ink absorbent material 38 is provided in a state fitted in a groove 39a of an ink absorbent holder 39 such that it is located in parallel with a feed path of the card C and at the same time at a location slightly below the same. In the embodiment, out of ink droplets ejected from the print head 11, ink droplets which miss the card C hit the ink absorbent material 38 and are absorbed thereby. Further, it is also possible to use the ink absorbent material 38 as an absorbent material for absorbing waste ink ejected from the print head 11 when a flushing operation is executed.

The supply roller 31 is arranged below a front portion of the card-setting block 3 such that the supply roller 31 is brought into rolling contact with an underside surface of an undermost card C. A front wall 3a forming a part of the card-setting block 3 has a bottom thereof extending downward to such a position as permits only the undermost card C to pass thereunder, whereby a card C lying upon the undermost card C is prevented from being moved forward even if it attempts to move together with the undermost card C being fed by the supply roller 31. This makes it possible to feed or advance the cards C one by one when the supply roller 31 is driven for rotation by the supply motor 34.

The feed roller means 32 is comprised of a feed drive roller 41 positioned below, for being driven for rotation by the feed motor 35, and a feed driven roller 42 positioned above for being brought into rolling contact with the feed drive roller 41 with the card C positioned therebetween. The feed driven roller 42, which is permitted to freely rotate and urged toward the feed drive roller 41 by a spring, not shown, sandwiches the card C between the same and the feed drive roller 41 in a manner urging the card C, and at the same time is driven for rotation by the rotation of the feed drive roller 41, thereby advancing the card C.

Similarly, the delivery roller means 33 is comprised of a delivery drive roller 44 positioned below for being driven for rotation by the delivery motor 36, and a delivery driven roller 45 positioned above for being brought into rolling contact with the delivery drive roller 44 with the card C positioned therebetween. The delivery driven roller 45, which is permitted to freely rotate and urged toward the delivery drive roller 44 by a spring, not shown, sandwiches the card C between the same and the delivery drive roller 44 in a manner urging the card C, and at the same time is driven for rotation by the rotation of the delivery drive roller 44, thereby advancing the card C.

Now, a controlling method of controlling the card feed mechanism 6 and the card printing mechanism 5 by the controller 7 is described hereinafter. In a sequence of printing operations, the card C received from the supply roller 31 is intermittently fed with intermittent rotations of the feed roller means 32 and the delivery roller means 33, and when the intermittent feed of the card C is stopped, the print head 11 is caused to reciprocate for carrying out a line of printing. More specifically, slight feed of the card C, the stop of feed of the card, and ejection of ink droplets performed by the print head 11 being intermittently moved are repeatedly carried out, whereby it is possible to print a desired image on the card C while being advanced to the card exit 4.

On the other hand, in the present embodiment, in view of a printing object being the card C, ink droplets are ejected by the print head 11 up to areas slightly beyond the four edges of the card C so as to positively print a background or the like up to all the four edges. In other words, the print head 11 is controlled such that the same is capable of performing beyond-edge printing in which ink droplets are ejected beyond the four edge portions of the card C.

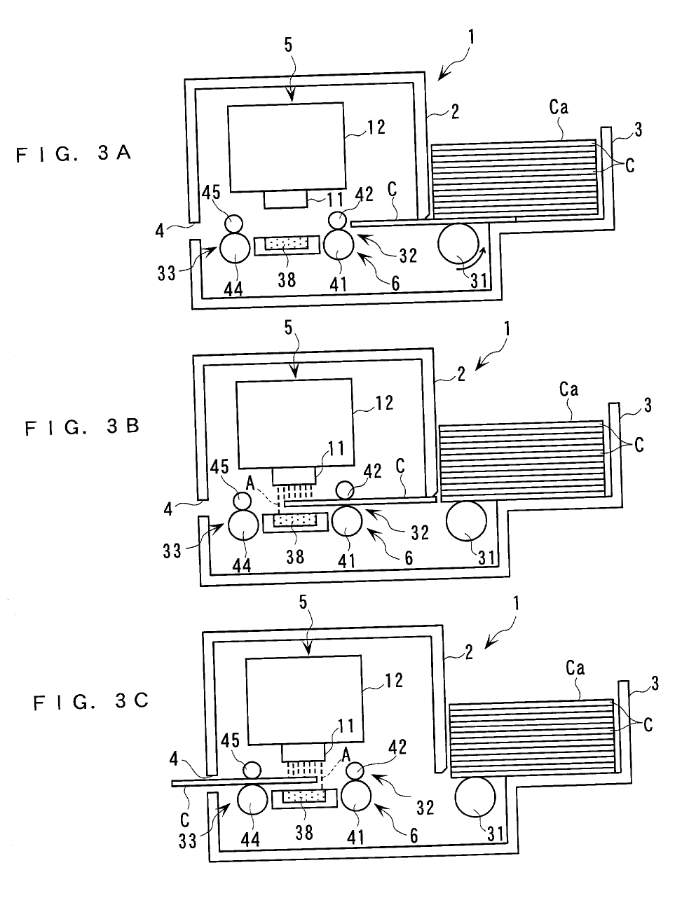

Referring to FIGS. 3A to 3C, a leading edge (front end) and a trailing edge (rear end) of the card C in the direction of feed thereof are printed during a time period over which the intermittent feed of the card C is stopped, as described above. Hence, a first line of printing and a last line of the printing are carried out on areas slightly off the leading edge and the trailing edge of the card C, respectively (by beyond-edge printing). Further, during the beyond-edge printing, the card C is fed by either of the feed roller means 32 and the delivery roller means 33. Therefore, in the present embodiment, a feeding speed of the feed roller means 32 (actually, feeding speed of intermittent feed thereof), and a feeding speed of the delivery roller means 33 (actually, feeding speed of intermittent feed thereof) are controlled such that they are made identical to each other.

More specifically, the feed motor 35 and the delivery motor 36 are implemented by DC motors respectively, and at the same time each of them has an encoder 40 connected thereto. The controller 7 controls the feed motor 35 and the delivery motor 36 based on the numbers of rotations of the respective DC motors detected by the encoders 40 such that the feeding speed of the feed roller means 32 and that of the delivery roller means 33 are made identical to each other (see FIGS. 1A and 1B). It should be noted that it is also possible to employ a stepping motor in place of a combination of the DC motor and the encoder.

In the present embodiment, since the card C is fed only in one direction, it is also possible to simplify the construction of the card feed mechanism 6, as shown in FIG. 1B. The card feed mechanism 6 shown in the figure is configured such that the feed motor 35 and the delivery motor 36 are driven by a single drive motor 48. In this case, a reduction gear train 49 is linked to the drive motor 48, and the torque of the drive motor 48 is branched by the reduction gear train 49 to be transmitted to the feed roller means 32 and the delivery roller means 33. This causes the feed roller means 32 to rotate at the same peripheral velocity as the delivery roller means 33.

On the other hand, when side edge portions of the card C are printed, ink droplets A ejected then during the reciprocating motion of the head unit 12 are caused to hit areas beyond the side edges of the card C to thereby carry out beyond-edge printing. In the above-mentioned beyond-edge printing for printing on the leading and trailing edge portions of the card C, the ink droplets A are ejected along opposite end faces of the card C in parallel therewith (FIGS. 3B and 3C). Therefore, the ink droplets A which have hit the leading and trailing edge portions of the card C hit the top surface of the card C, whereas the ink droplets A which deviate from the edge portions pass by the card C to hit the ink absorbent material 38. This prevents the ink droplets A from hitting the leading and trailing end faces of the card C.

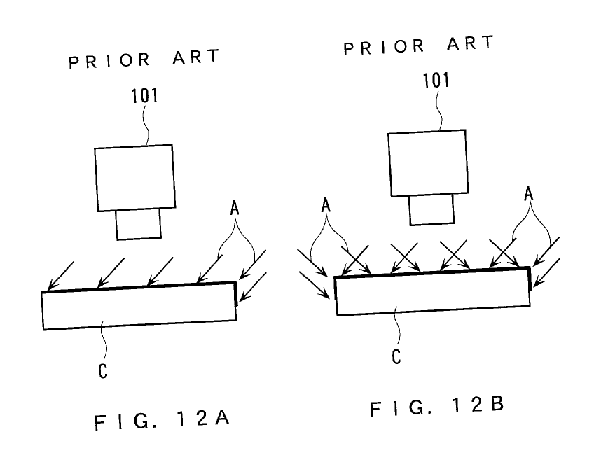

On the other hand, in beyond-edge printing for printing on the side edge portions of the card C, the print head 11 ejects the ink droplets A while being reciprocatingly moved, thereby causing the ink droplets A to hit the card C from a relatively slanting direction. As a result, as shown in FIGS. 12A and 12B, the ink droplets A are caused to hit one side end face on this side of the card C in the direction of movement of the print head 101, from a slanting direction. Inversely, the ink droplets A cannot hit the other side end face of the card C on the remote side thereof in the direction of movement of the print head 101. To overcome this problem, in the present embodiment, the following method is adopted in view of the ink droplets A hitting (being ejected onto) the card C from a relatively slanting direction.

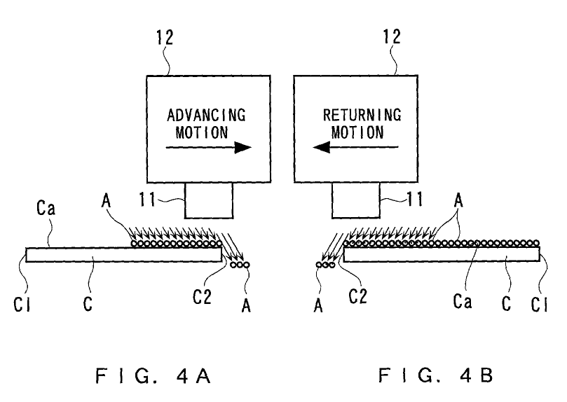

Referring to FIGS. 4A and 4B, when beyond-edge printing is carried out in the direction of movement (reciprocation) of the print head 11, during a printing operation in the direction of an advancing motion of the print head 11 (the motion of the same from a left side to a right side as viewed in FIGS. 4A and 4B), the ink droplets A are ejected from an area on the card C to an area beyond a front side edge portion C2 of the card C so as to prevent the ink droplets A from being ejected onto a rear side edge portion Cl. Similarly, also during a printing operation in the direction of a returning motion of the print head 11, the ink droplets A are ejected from an area on the card C to an area beyond the front side edge portion C2 of the card C so as to prevent the ink droplets A from being ejected onto the rear side edge portion C1. In other words, a printing method is employed in which beyond-edge printing is carried out only immediately before termination of the ejection of the ink droplets A both when the print head 11 is advanced and when the print head 11 is returned, whereas immediately after the start of the ejection of the ink droplets A, beyond-edge printing is not carried out.

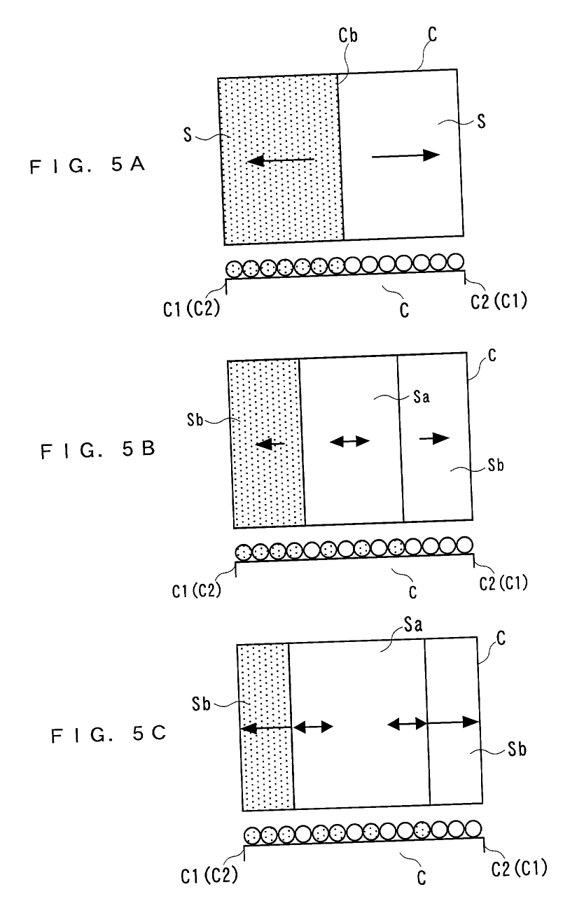

FIGS. 5A to 5C represent the above printing method in a further detailed manner. In FIG. 5A, a whole printing area of the card C is divided into two areas S and S to be printed during the advancing and returning motions of the print head 11, respectively, such that beyond-edge printing is performed forward of a center line Cb of the card C in the direction of the width thereof. That is, a front half of the card C is printed during the advancing motion of the print head 11 and similarly, a front half (the other half) of the card C is printed during the returning motion of the print head such that consequently, the whole printing area of the card C can be printed. Although in the present embodiment, the left and right printing areas S and S are divided by the center line Cb of the card C, a boundary dividing between the printing areas is not necessarily required to be the center line Cb.

On the other hand, in FIG. SB, portions printed in beyond-edge printing during the advancing motion of the print head 11 and in beyond-edge printing during the returning motion of the print head 11 overlap each other at an intermediate portion of the card C. In this case, if the beyond-edge printing operations are simply carried in a manner causing the above printed portions to overlap each other, an overlapping portion Sa comes to be printed with a higher print density than non-overlapping portions Sb. To eliminate this inconvenience, an amount of the ink droplets A ejected onto the overlapping portion Sa per unit image and an amount of the ink droplets A ejected onto each non-overlapping portion Sb per unit image are controlled to be equal to each other. More specifically, in each of the printing operations carried out during the advancing and returning motions of the print head 11, the amount of ink ejected onto the overlapping portion Sa per unit image is controlled to be equal to one half of the amount of ink ejected onto each non-overlapping portions Sb per unit image. However, in the overlapping portion Sa, the amount of ink ejected during an advancing motion of the print head and the amount of ink ejected during a returning motion of the print head are not necessarily equal. Thus, it is possible to form a whole image in which an image printed on the overlapping portion Sa and an image printed on each non-overlapping portion Sb can be identical in color perception and are equal in print quality to each other.

In FIG. 5C, in each of the printing operations carried out during the advancing and returning motions of the print head 11, an amount of ink ejected per unit image is increased progressively (stepwise, continuously) as the printing area is sifted from an overlapping portion Sa toward a non-overlapping portion Sb, whereby a whole amount of the ink droplets A ejected onto the overlapping portion Sa per unit image is controlled to be equal to a whole amount of the inkdroplets A ejected onto each non-overlapping portions Sb per unit image.

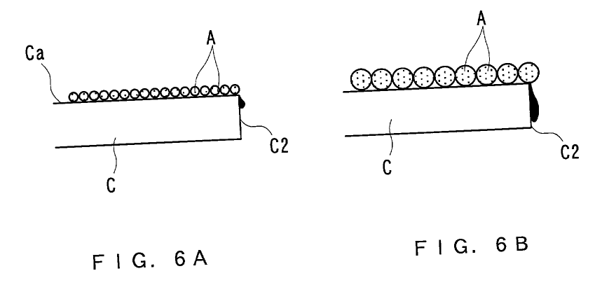

Further, as shown in FIGS. 6A and 6B, in the present embodiment, by ejecting a lot of small ink droplets A are ejected, a flow of ink (trickling of ink) from an edge portion of the card C to a side end face C2 thereof is controlled to be minimized (FIG. 6A). That is, the print head 11 is controlled to discharge very fine ink droplets A which, for instance, are equal in diameter to minimum dots the print head allows. FIG. 6B shows a state in which normal ink droplets A are ejected on the card C. In this case, the ink droplets A are large in size, and an amount of flow of ink (amount of trickling ink) from the edge portion of the card C to the side end face C2 thereof is increased. Further, it is preferred that the amount of ink ejected per unit image in FIG. 6A is equal to the amount of ink ejected per unit image in FIG. 6B. Further, the ink droplets A may be controlled to be fine when the printing operation is to be carried out on an edge portion of the card C.

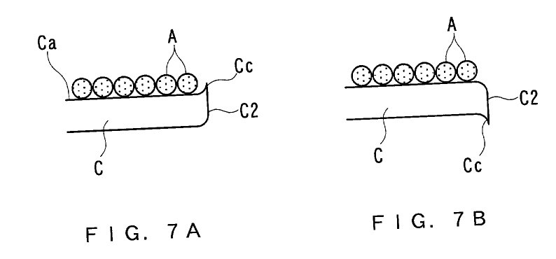

Now, as shown in FIGS. 7A and 7B, when a card C is formed by blanking, a droop portion Cc in the form of burrs is created at an edge portion of the card C. In the present embodiment, beyond-edge printing is carried out by employing a droop surface side having the droop portion Cc thereon as a recording surface Ca (FIG. 7A). This makes it possible to cause the droop portion Cc to function as a wall for preventing the ink droplets A adhering to a side edge portion of the card C from trickling down to a side end face C2 of the card C. FIG. 7B shows a case in which beyond-edge printing is carried out on a surface opposite to the droop surface. In this case, it becomes easy for the ink droplets A to trickle down the side end face C2 of the card C. Although in a case of the both surfaces of the card C being printed, there is no choice of surfaces to be printed, when only one surface is subjected to beyond-edge printing, the droop surface side is used as this surface i.e. recording surface Ca for the beyond-edge printing.

As described hereinbefore, according to the present embodiment, beyond-edge printing is carried out by changing printing areas depending on whether the print head 11 is advanced or returned, and hence it is possible to prevent the ink droplets A from directly hitting the side end faces C1 and C2 of the card C, thereby preventing or minimizing the possibility of adhesion of ink to the side end faces C1 and C2 of the card C.

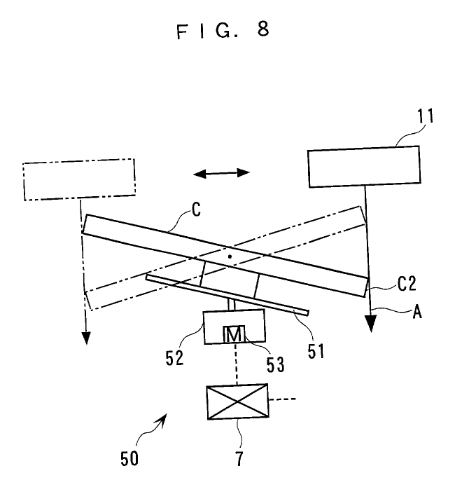

Next, a second embodiment of the invention will be described with reference to FIG. 8. In this embodiment, the card C is tilted in a left-right direction in synchronism with reciprocating motion of the print head 11. In this embodiment, the above-mentioned feed roller means 32 and delivery roller means 33 and the like are supported on a base frame 51 which is connected to a tilting mechanism 50 for tilting the card C leftward and rightward with respect to the location of the center of the card C in a left-right direction. The tilting mechanism 50 includes a link mechanism 52 for tilting the card C, and a tilting motor 53 for actuating the link mechanism 52. The tilting motor 53 is connected to the controller 7 described hereinabove.

The controller 7 drives the tilting motor 53 in a manner synchronous with reciprocation of the print head 11, thereby tilting the card C in a direction of movement of the print head 11 such that the card C slopes downward in this direction. In short, the card C is performs seesawing motion in synchronism with reciprocation of the print head 11. Therefore, when beyond-edge printing is carried out on each edge portion of the card C, the ink droplets A hit the edge portion at a small angle from a slanting direction, thereby positively preventing the ink droplets A from adhering to the side edge portion C2 of the card C. This makes it possible to positively prevent adhesion of ink to the side edge portions C1 and C2 of the card C.

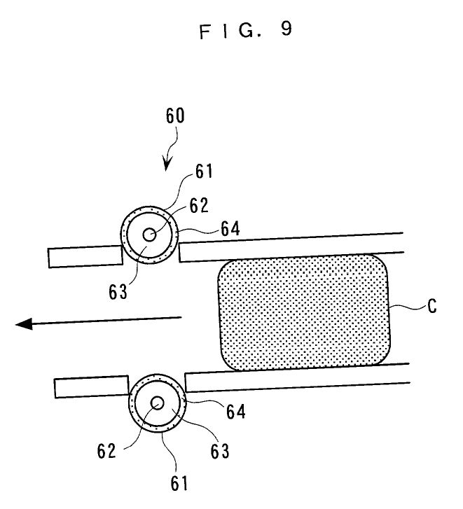

Next, a third embodiment of the invention will be described with reference to FIG. 9. In this embodiment, ink which has adhered to the side edge portions C1 and C2 of the card C is wiped off before the card C is delivered out of the apparatus. A wiping device 60 is interposed between the delivery roller means 33 and the card exit 4. The wiping device 60 is comprised of a pair of left and right wiping rollers 61 and 61. The pair of wiping rollers 61 and 61 face a feed path of the card C from respective transverse (left-right) directions, and brakingly rotates as the card C passes.

Each wiping roller 61 is comprised of a support shaft 62 attached to a frame, not shown, and a roller body 63 brakingly rotates with respect to the support shaft 62. As the card C is advanced, the roller bodies 63 are brought into rolling contact with the card C, whereby wiping members 64 arranged on respective outer peripheries of the roller bodies 63 are brought into sliding contact with the side end faces C1 and C2 of the card C, thereby wiping ink from the side edge portions C1 and C2. Therefore, even if ink adheres to the opposite side end faces C1 and C2 during printing, it is possible to wipe off the ink from the side edge portions C1 and C2 as the card C is sent out of the apparatus.

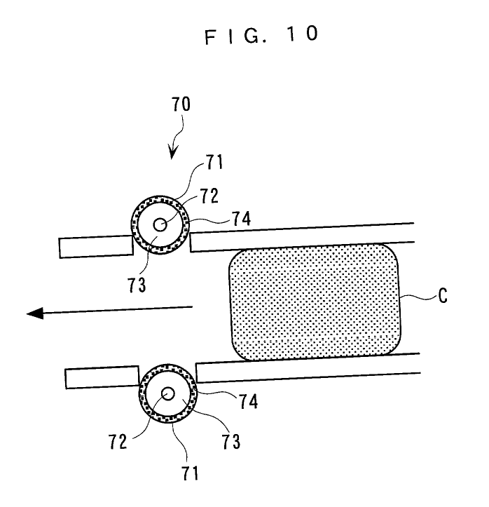

FIG. 10 shows a variation of the third embodiment described above. In this variation, a scraping device 70 is arranged which includes grinding rollers 71 and 71 in place of the wiping rollers 61 and 61 described above. Each of the grinding rollers 71 and 71 includes a grinding member 74 on an outer periphery of a roller body 73 which brakingly rotates with respect to a support shaft 72. In this example, as the card C is advanced, the roller bodies 73 are brought into rolling contact with the card C, whereby the grinding members 74 chip off ink adhering to the side edge portions C1 and C2 of the card C. It should be noted that the third embodiment can be applied to a card printing apparatus which does not assume a special printing mode for printing as in the case of the first embodiment.

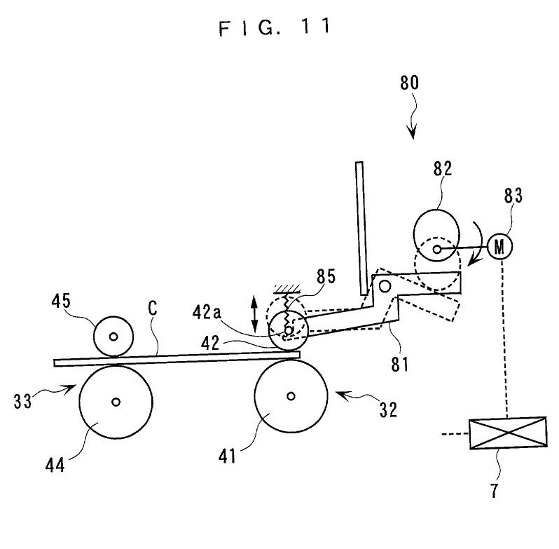

Next, a fourth embodiment of the invention will be described with reference to FIG. 11. As described above, the card C has a predetermined thickness. Therefore, as the card C is advanced, and when the trailing edge portion of the card C leaves the feed roller means 32, the urging force (urging force by a spring) of the feed driven roller 42 applied to the feed drive roller 41 acts on the card C in a manner flicking or flipping the card C forward. The card C which is sandwiched and urged by the delivery roller means 33 on a front side thereof is flicked by the feed roller means 32, and slightly advanced in a slipping manner. At this time, if the printing operation is continued, thinned dots are printed on the card C. To overcome this problem, in this embodiment, an urging-force release mechanism 80 is arranged which releases the card C from the state held and urged by the feed driven roller 42 when the trailing edge portion of the card C leaves the feed roller means 32.

The urging-force release mechanism 80 includes a pivot arm (release arm) 81 for spacing the feed driven roller 42 from the feed drive roller 41, a cam 82 for causing the pivot arm 81 to be pivotally moved, and a release motor 83 for rotating the cam 82. The pivot arm 81 has one end portion thereof engaged with a support shaft 42a of the feed driven roller 42, the other end portion thereof brought into contact with the cam 82 and an intermediate portion thereof pivotally supported on a frame, not shown. In this embodiment, the pivot arm 81 causes the feed driven roller 42 to move upward and downward between a rolling contact position and a spaced position. On the other hand, the release motor 83 is connected to the above-mentioned controller 7 which detects a timing at which the trailing edge portion of the card C leaves the feed roller means 32, based on the number of feeding steps and a feed time period of the feed roller means (the feed motor 35) 32, and drives the release motor 83 at the timing.

When the release motor 83 is driven, the cam 82 is driven for rotation via a speed reduction mechanism, not shown. The rotation of the cam 82 causes the pivotal movement of the pivot arm 81. When the pivot arm 81 is driven for operation, the feed driven roller 42 is moved upward against a spring 85 to be slightly spaced from the trailing edge portion of the card C. As a result, the trailing edge portion of the card C is released, and the card C is advanced by the delivery roller means 33.

As described hereinabove, the urging-force release mechanism 80 is incorporated in the feed roller means 32, whereby the card C having a predetermined thickness is prevented from being flicked by the feed roller means 32. Hence, a faulty printing operation can be prevented even if the trailing edge portion of the card C leaves the feed roller means 32 during printing operation (especially, beyond-edge printing). It should be noted that a solenoid may be used as a drive source in place of the release motor 83. In this case, the pivot arm 81 is connected to a plunger of the solenoid. Further, although in the above case, the feed driven roller 42 is moved upward by the pivot arm 81, this is not limitative, but the support shaft 42a of the feed driven roller 42 maybe supported from below and a spring force of the spring 85 man be caused to escape to the pivot arm 81 (in this case, the pivot arm 81 is engaged with and disengaged from the feed driven roller 42 via the support shaft 42a). Furthermore, the apparatus may be configured such that a stator of the spring 85 is lifted by the pivot arm 81.

As described hereinbefore, according to the card printing apparatus of the invention, during the printing operation, when the card being fed reaches the position of the pair of feed rollers, the release mechanism stops the feed rollers from urgingly sandwiching the card therebetween, and hence the flipping force is prevented from acting on the card. Therefore, even when the card leaves the feed rollers while the print head continues printing on the card, it is possible to prevent thinned dots from being printed thereon, thereby enhancing the print quality.

It is further understood by those skilled in the art that the foregoing are preferred embodiments of the invention, and that various changes and modifications may be made without departing from the spirit and scope thereof.

What is claimed is:

1. A card printing apparatus for printing on a card having a predetermined thickness and a trailing edge portion, by an ink jet printing method, the card printing apparatus comprising:
a pair of feed rollers for feeding said card forward while urgingly sandwiching said card therebetween;
a print head for printing on said card being fed, while performing reciprocating motions; and
a release mechanism for causing said pair of rollers to stop urgingly sandwiching said card therebetween; and
a controller for controlling said release mechanism such that said release mechanism causes said pair of rollers to stops urgingly sandwiching said card therebetween when said trailing edge portion of said card reaches a position of said pair of feed rollers.

2. A card printing apparatus according to claim 1, wherein said pair of rollers comprise a driving roller and a driven roller urged toward said driving roller, and wherein said release mechanism causes said pair of rollers to stop urgingly sandwiching said card by freeing said driven roller from an urged condition.

3. A card printing apparatus according to claim 1, wherein said pair of rollers comprise a driving roller and a driven roller urged toward said driving roller, and wherein said release mechanism causes said pair of rollers to stop urgingly sandwiching said card by spacing said driven roller away from said drive roller.

4. A card printing apparatus according to claim 2, including a support shaft on which said driven roller is fitted, and wherein said release mechanism includes:
a release arm disengageably associated with said support shaft such that said release arm can be shifted between a holding position in which said release arm engages with said support shaft of said driven roller for holding said driven roller in a rolling contact position, and a retracted position in which said release arm is withdrawn from said support shaft, and
an actuator for causing said release arm to operate.

5. A card printing apparatus according to claim 3, including a support shaft on which said driven roller is fitted, and wherein said release mechanism includes:
a release arm in engagement with said support shaft of said driven roller, said release arm moving said driven roller via said support shaft between a rolling contact position and a spaced-away position; and
an actuator for causing said release arm to operate.

6. A card printing apparatus according to claim 4, wherein said actuator comprises a solenoid.

7. A card printing apparatus according to claim 5, wherein said actuator comprises a solenoid.

8. A card printing apparatus according to claim 4, wherein said actuator comprise a motor, and a cam driven by said motor for rotation, and wherein said cam constitutes a cam mechanism together with said release arm.

9. A card printing apparatus according to claim 5, wherein said actuator comprise a motor, and a cam driven by said motor for rotation, and wherein said cam constitutes a cam mechanism together with said release arm.

10. A card printing apparatus according to claim 1, wherein said controller detects an amount of feed of said card effected by said pair of feed rollers, and controls said release mechanism based on results of the detection.

11. A card printing apparatus for printing on a card having a predetermined thickness by an ink jet printing method, the card printing apparatus comprising:
a card feed mechanism for feeding said card;
a print head for printing on said card being fed, while performing reciprocating motions; and
a controller for controlling said card feed mechanism and said print head,
wherein said card feed mechanism includes feed roller means and delivery roller means arranged at respective upstream and downstream locations in a direction of feed of said card with respect to said print head, and
wherein said controller controls feeding operations of said feed roller means and said delivery roller means in synchronism with a printing operation of said print head.
